(19) United States
(12) Patent Application Publication
(10) Pub. No.: US 2013/0281728 A1
(43) Pub. Date: Oct. 24, 2013

(54) 1,3-AZABORINES

(71) Applicants: Shih-Yuan Liu, Eugene, OR (US); Senmiao Xu, Eugene, OR (US)

(72) Inventors: Shih-Yuan Liu, Eugene, OR (US); Senmiao Xu, Eugene, OR (US)

(73) Assignee: State Board of Higher Education on behalf of University of Oregon

(21) Appl. No.: 13/865,892

(22) Filed: Apr. 18, 2013

Related U.S. Application Data
(60) Provisional application No. 61/635,107, filed on Apr. 18, 2012.
(60) Provisional application No. 61/650,893, filed on May 23, 2012.

(51) Int. Cl. C07F 5/02

(52) U.S. Cl. CPC C07F 5/02
USPC 560/231; 564/9; 562/806; 564/8

(57) ABSTRACT

A compound having a structure of:

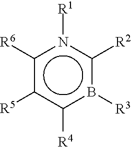

wherein each of R¹-R⁶ is individually H, halogen, hydroxyl, amino, optionally substituted alkoxy, optionally substituted alkyl, optionally substituted alkenyl, optionally substituted alkynyl, optionally substituted aryl, optionally substituted acyl, optionally substituted acyloxy, optionally substituted cycloalkyl, optionally substituted heterocycloalkyl, optionally substituted heteroaryl, optionally substituted aryloxy, optionally substituted heteroaryloxy, optionally substituted heterocycloxy, halogenated alkyl, thioether, optionally substituted thiol, ester, aminocarbonyl, amido, nitro, silyl, sulfinyl, sulfonyl, or phosphino.

### CROSS-REFERENCE TO RELATED APPLICATIONS

This application claims the benefit of U.S. Provisional Application No. 61/635,107, which was filed on Apr. 18, 2012, and U.S. Provisional Application No. 61/650,893, which was filed on May 23, 2012, both of which are incorporated herein by reference in their entirety.

### ACKNOWLEDGMENT OF GOVERNMENT SUPPORT

This invention was made with government support under NIGMS RO1-GM094541 awarded by the National Institutes of Health. The government has certain rights in the invention.

### SUMMARY

Disclosed herein are compounds having a structure of:

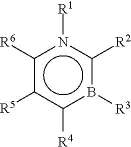

wherein each of R¹-R⁶ is individually H, halogen, hydroxyl, amino, optionally substituted alkoxy, optionally substituted alkyl, optionally substituted alkenyl, optionally substituted alkynyl, optionally substituted aryl, optionally substituted acyl, optionally substituted acyloxy, optionally substituted cycloalkyl, optionally substituted heterocycloalkyl, optionally substituted heteroaryl, optionally substituted aryloxy, optionally substituted heteroaryloxy, optionally substituted heterocycloxy, halogenated alkyl, thioether, optionally substituted thiol, ester, aminocarbonyl, amido, nitro, silyl, sulfinyl, sulfonyl, or phosphino.

The foregoing will become more apparent from the following detailed description, which proceeds with reference to the accompanying figures.

### BRIEF DESCRIPTION OF THE DRAWINGS

FIG. 1 shows ORTEP illustrations, with thermal ellipsoids drawn at the 35% probability level, of compound 4.

FIG. 2 depicts the synthesis and characterization of Piano Stool Complex 11

FIG. 3 depicts several illustrative 1,3-dihydro-1,3-azaborine compounds, and synthesis paths for making the compounds.

### DETAILED DESCRIPTION

### Terminology

The following explanations of terms and methods are provided to better describe the present compounds, compositions and methods, and to guide those of ordinary skill in the art in the practice of the present disclosure. It is also to be understood that the terminology used in the disclosure is for the purpose of describing particular embodiments and examples only and is not intended to be limiting.

An “R-group” or “substituent” refers to a single atom (for example, a halogen atom) or a group of two or more atoms that are covalently bonded to each other, which are covalently bonded to an atom or atoms in a molecule to satisfy the valency requirements of the atom or atoms of the molecule, typically in place of a hydrogen atom. Examples of R-groups/substituents include alkyl groups, hydroxyl groups, alkoxy groups, acyloxy groups, mercapto groups, and aryl groups.

“Substituted” or “substitution” refer to replacement of a hydrogen atom of a molecule or an R-group with one or more additional R-groups such as halogen, alkyl, alkoxy, alkylthio, trifluoromethyl, acyloxy, hydroxy, mercapto, carboxy, aryloxy, aryl, arylalkyl, heteroaryl, amino, alkylamino, dialkylamino, morpholino, piperidino, pyrrolidin-1-yl, piperazin-1-yl, nitro, sulfato or other R-groups.

“Acyl” refers to a group having the structure —C(O)R, where R may be, for example, optionally substituted alkyl, optionally substituted aryl, or optionally substituted heteroaryl. “Lower acyl” groups are those that contain one to six carbon atoms.

“Acyloxy” refers to a group having the structure —OC(O)R—, where R may be, for example, optionally substituted alkyl, optionally substituted aryl, or optionally substituted heteroaryl. “Lower acyloxy” groups contain one to six carbon atoms.

“Alkenyl” refers to a cyclic, branched or straight chain group containing only carbon and hydrogen, and unless otherwise mentioned typically contains one to twelve carbon atoms, and contains one or more double bonds that may or may not be conjugated. Alkenyl groups may be unsubstituted or substituted. “Lower alkenyl” groups contain one to six carbon atoms.

The term “alkoxy” refers to a straight, branched or cyclic hydrocarbon configuration and combinations thereof, including from 1 to 20 carbon atoms, preferably from 1 to 8 carbon atoms (referred to as a “lower alkoxy”), more preferably from 1 to 4 carbon atoms, that include an oxygen atom at the point of attachment. An example of an “alkoxy group” is represented by the formula —OR, where R can be an alkyl group, optionally substituted with an alkenyl, alkynyl, aryl, aralkyl, cycloalkyl, halogenated alkyl, alkoxy or heterocycloalkyl group. Suitable alkoxy groups include methoxy, ethoxy, n-propoxy, i-propoxy, n-butoxy, i-butoxy, sec-butoxy, tert-butoxy cyclopropoxy, cyclohexyloxy, and the like.

“Alkoxycarbonyl” refers to an alkoxy substituted carbonyl radical, —C(O)OR, wherein R represents an optionally substituted alkyl, aryl, aralkyl, cycloalkyl, cycloalkylalkyl or similar moiety.

The term “alkyl” refers to a branched or unbranched saturated hydrocarbon group of 1 to 24 carbon atoms, such as methyl, ethyl, n-propyl, isopropyl, n-butyl, isobutyl, t-butyl, pentyl, hexyl, heptyl, octyl, decyl, tetradecyl, hexadecyl, eicosyl, tetracosyl and the like. A “lower alkyl” group is a saturated branched or unbranched hydrocarbon having from 1 to 6 carbon atoms. Preferred alkyl groups have 1 to 4 carbon atoms. Alkyl groups may be “substituted alkyls” wherein one or more hydrogen atoms are substituted with a substituent such as halogen, cycloalkyl, alkoxy, amino, hydroxyl, aryl, alkenyl, or carboxyl. For example, a lower alkyl or (C₁-C₆)alkyl can be methyl, ethyl, propyl, isopropyl, butyl, iso-butyl, sec-butyl, pentyl, 3-pentyl, or hexyl; (C₃-C₆)cycloalkyl can be cyclopropyl, cyclobutyl, cyclopentyl, or cyclohexyl; (C₃-C₆)cycloalkyl(C₁-C₆)alkyl can be cyclopropylmethyl, cyclobutylmethyl, cyclopentylmethyl, cyclohexylmethyl, 2-cyclopropylethyl, 2-cyclobutylethyl, 2-cyclopentylethyl, or 2-cyclohexylethyl; (C₁-C₆)alkoxy can be methoxy, ethoxy, propoxy, isopropoxy, butoxy, iso-butoxy, sec-butoxy, pentoxy, 3-pentoxy, or hexyloxy; (C₂-C₆)alkenyl can be vinyl, allyl, 1-propenyl, 2-propenyl, 1-butenyl, 2-butenyl, 3-butenyl, 1,-pentenyl, 2-pentenyl, 3-pentenyl, 4-pentenyl, 1-hexenyl, 2-hexenyl, 3-hexenyl, 4-hexenyl, or 5-hexenyl; (C₂-C₆)alkynyl can be ethynyl, 1-propynyl, 2-propynyl, 1-butynyl, 2-butynyl, 3-butynyl, 1-pentynyl, 2-pentynyl, 3-pentynyl, 4-pentynyl, 1-hexynyl, 2-hexynyl, 3-hexynyl, 4-hexynyl, or 5-hexynyl; (C₁-C₆)alkanoyl can be acetyl, propanoyl or butanoyl; halo(C₁-C₆)alkyl can be iodomethyl, bromomethyl, chloromethyl, fluoromethyl, trifluoromethyl, 2-chloroethyl, 2-fluoroethyl, 2,2,2-trifluoroethyl, or pentafluoroethyl; hydroxy(C₁-C₆)alkyl can be hydroxymethyl, 1-hydroxyethyl, 2-hydroxyethyl, 1-hydroxypropyl, 2-hydroxypropyl, 3-hydroxypropyl, 1-hydroxybutyl, 4-hydroxybutyl, 1-hydroxypentyl, 5-hydroxypentyl, 1-hydroxyhexyl, or 6-hydroxyhexyl; (C₁-C₆)alkoxycarbonyl can be methoxycarbonyl, ethoxycarbonyl, propoxycarbonyl, isopropoxycarbonyl, butoxycarbonyl, pentoxycarbonyl, or hexyloxycarbonyl; (C₁-C₆)alkylthio can be methylthio, ethylthio, propylthio, isopropylthio, butylthio, isobutylthio, pentylthio, or hexylthio; (C₂-C₆)alkanoyloxy can be acetoxy, propanoyloxy, butanoyloxy, isobutanoyloxy, pentanoyloxy, or hexanoyloxy.

“Alkynyl” refers to a cyclic, branched or straight chain group containing only carbon and hydrogen, and unless otherwise mentioned typically contains one to twelve carbon atoms, and contains one or more triple bonds. Alkynyl groups may be unsubstituted or substituted. “Lower alkynyl” groups are those that contain one to six carbon atoms.

The term “amine” or “amino” refers to a group of the formula —NRR′, where R and R′ can be, independently, hydrogen or an alkyl, alkenyl, alkynyl, aryl, aralkyl, cycloalkyl, halogenated alkyl, or heterocycloalkyl group. For example, an “alkylamino” or “alkylated amino” refers to —NRR′, wherein at least one of R or R′ is an alkyl.

“Aminocarbonyl” alone or in combination, means an amino substituted carbonyl (carbamoyl) radical, wherein the amino radical may optionally be mono- or di-substituted, such as with alkyl, aryl, aralkyl, cycloalkyl, cycloalkylalkyl, alkanoyl, alkoxycarbonyl, aralkoxycarbonyl and the like. An aminocarbonyl group may be —N(R)—C(O)—R (wherein R is a substituted group or H). A suitable aminocarbonyl group is acetamido.

The term “amide” or “amido” is represented by the formula —C(O)NRR′, where R and R′ independently can be a hydrogen, alkyl, alkenyl, alkynyl, aryl, aralkyl, cycloalkyl, halogenated alkyl, or heterocycloalkyl group described above.

“Aryl” refers to a monovalent unsaturated aromatic carbocyclic group having a single ring (e.g., phenyl) or multiple condensed rings (e.g., naphthyl or anthryl), which can optionally be unsubstituted or substituted. A “heteroaryl group,” is defined as an aromatic group that has at least one heteroatom incorporated within the ring of the aromatic group. Examples of heteroatoms include, but are not limited to, nitrogen, oxygen, sulfur, and phosphorous. Heteroaryl includes, but is not limited to, pyridinyl, pyrazinyl, pyrimidinyl, pyrrolyl, pyrazolyl, imidazolyl, thiazolyl, oxazolyl, isooxazolyl, thiadiazolyl, oxadiazolyl, thiophenyl, furanyl, quinolinyl, isoquinolinyl, benzimidazolyl, benzooxazolyl, quinoxalinyl, and the like. The aryl or heteroaryl group can be substituted with one or more groups including, but not limited to, alkyl, alkynyl, alkenyl, aryl, halide, nitro, amino, ester, ketone, aldehyde, hydroxy, carboxylic acid, or alkoxy, or the aryl or heteroaryl group can be unsubstituted.

“Aryloxy” or “heteroaryl” refers to a group of the formula —OAr, wherein Ar is an aryl group or a heteroaryl group, respectively.

The term “carboxylate” or “carboxyl” refers to the group —COO⁻ or —COOH.

The term “ester” refers to a carboxyl group having the hydrogen replaced with, for example a C₁₋₆alkyl group (“carboxylC₁₋₆alkyl” or “alkylester”), an aryl or aralkyl group (“arylester” or “aralkylester”) and so on. CO₂C₁₋₃alkyl groups are preferred, such as for example, methylester (CO₂Me), ethylester (CO₂Et) and propylester (CO₂Pr) and includes reverse esters thereof (e.g. —OCOMe, —OCOEt and —OCOPr).

The term “cycloalkyl” refers to a non-aromatic carbon-based ring composed of at least three carbon atoms. Examples of cycloalkyl groups include, but are not limited to, cyclopropyl, cyclobutyl, cyclopentyl, cyclohexyl, and the like. The term “heterocycloalkyl group” is a cycloalkyl group as defined above where at least one of the carbon atoms of the ring is substituted with a heteroatom such as, but not limited to, nitrogen, oxygen, sulfur, or phosphorous. “Heterocycloalkyl” and “heterocyclic” are used interchangeably herein.

The term “halogen” refers to fluoro, bromo, chloro and iodo substituents.

The terms ‘halogenated alkyl” or “haloalkyl group” refer to an alkyl group as defined above with one or more hydrogen atoms present on these groups substituted with a halogen (F, Cl, Br, I).

The term “hydroxyl” is represented by the formula —OH.

“Nitro” refers to an R-group having the structure —NO₂.

The term “thioether” refers to a —S—R group, wherein R may be, for example, alkyl (including substituted alkyl), or aryl (including substituted aryl).

The term “thiol” refers to —SH. A “substituted thiol” refers to a —S—R group wherein R is not an aliphatic or aromatic group. For instance, a substituted thiol may be a halogenated thiol such as, for example, —SF₅.

Disclosed herein are 1,3-azaborine compounds having a structure of:

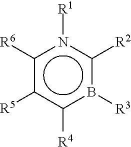

wherein each of R¹-R⁶ is individually H, halogen, hydroxyl, amino, optionally substituted alkoxy, optionally substituted alkyl, optionally substituted alkenyl, optionally substituted alkynyl, optionally substituted aryl, optionally substituted acyl, optionally substituted acyloxy, optionally substituted cycloalkyl, optionally substituted heterocycloalkyl, optionally substituted heteroaryl, optionally substituted aryloxy, optionally substituted heteroaryloxy, optionally substituted heterocycloxy, halogenated alkyl, thioether, optionally substituted thiol, ester, aminocarbonyl, amido, nitro, silyl, sulfinyl, sulfonyl, or phosphino.

In certain embodiments, each of R¹, R², R⁴, R⁵ and R⁶ is individually H or an alkyl.

In certain embodiments, R¹ and R³ are not each H. Preferably, R¹ is a C₁-C₆ alkyl, particularly methyl. In certain embodiments, R³ is H, halogen, hydroxyl, amino (particularly C₁-C₆ alkylamino), alkoxy (particularly C₁-C₆ alkoxy), acyl, acyloxy, heteroaryl, or heterocycloxy. In certain embodiments, R³ is optionally substituted alkyl (particularly C₁-C₆ alkyl), optionally substituted alkenyl (particularly C₂-C₆ alkenyl), optionally substituted aryl (particularly phenyl), optionally substituted alkynyl (particularly C₂-C₆ alkynyl), optionally substituted aryloxy (particularly phenoxy), optionally substituted alkoxy (particularly C₁-C₆ alkoxy), amino, or halogen.

In certain embodiments, each of R², R⁴, R⁵ and R⁶ is individually H.

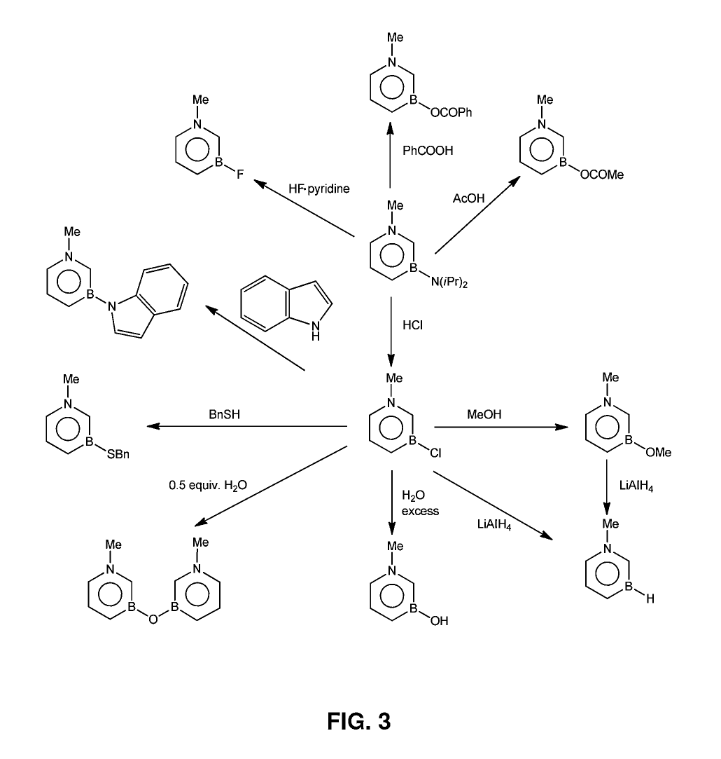

Illustrative compounds are shown in FIG. 3 and below.

### Synthesis

The compounds disclosed herein may be synthesized as described below and as shown in FIG. 3. Scheme 1 illustrates a retrosynthetic analysis for a 1,3-azaborine. It was envisioned that B-vinyl heterocycle B could potentially be poised to undergo dehydrogenation to furnish the target 1,3-azaborine A. Intermediate B could be prepared via ring closing metathesis (RCM) of diene C, which in turn should be accessible from the coupling of vinyl boron chloride D and allylamine E.

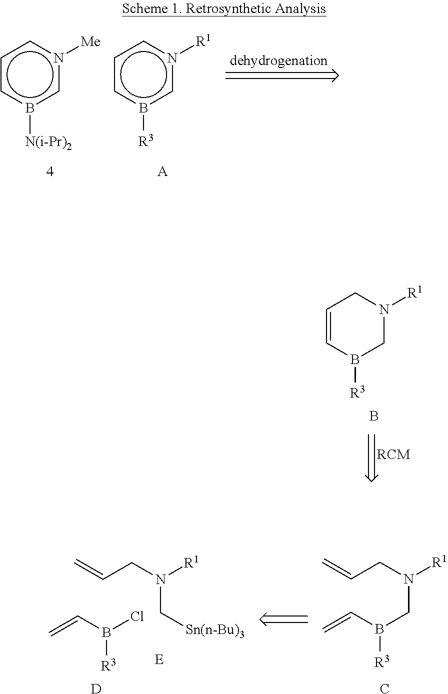

Recognizing a potentially detrimental Lewis acid (boron)-Lewis base (nitrogen lone pair) interaction in precursors B and C, we chose compound 4 (R¹=Me, R³═N(i-Pr)₂, see Scheme 1) as our initial 1,3-azaborine target to mitigate this issue. Scheme 2 below illustrates our synthesis of the penultimate compound 9. The reaction of N-methylallylamine with formaldehyde and 1,2,3-benzotriazole afforded intermediates 5 and 5′ (as a 4:1 mixture) in 97% yield. Deprotonation of n-Bu₃SnH with LDA followed by addition of the mixture of 5 and 5′ furnished 6 in 72% yield, with the 1,2,3-benzotriazole serving as a leaving group. Our initial attempts using direct transmetallation between stannane nucleophile 6 and the vinylboron chloride 7 were unsuccessful. However, lithium-tin exchange of 6 with n-hexyllithium followed by addition of electrophile 7 afforded the desired coupling product 8 in 67% yield. Grubbs 1^{st} generation and Schrock catalysts were then screened to examine the RCM reaction of 8. Disappointingly, these initial cyclization attempts met with failure, presumably due to degradation of RCM catalysts by the relatively nucleophilic amine group in 8. It has been demonstrated that the Grubbs 1^{st} generation catalyst is compatible with an ammonium salt. After screening a number of Broφnsted acids, we found triflic acid to be the most suitable protection agent for the nitrogen lone pair in 8. Thus, RCM reaction of 8.TfOH complex followed by deprotonation with DBU produced the desired heterocycle 9 in 47% overall yield (over 3 steps from 8).

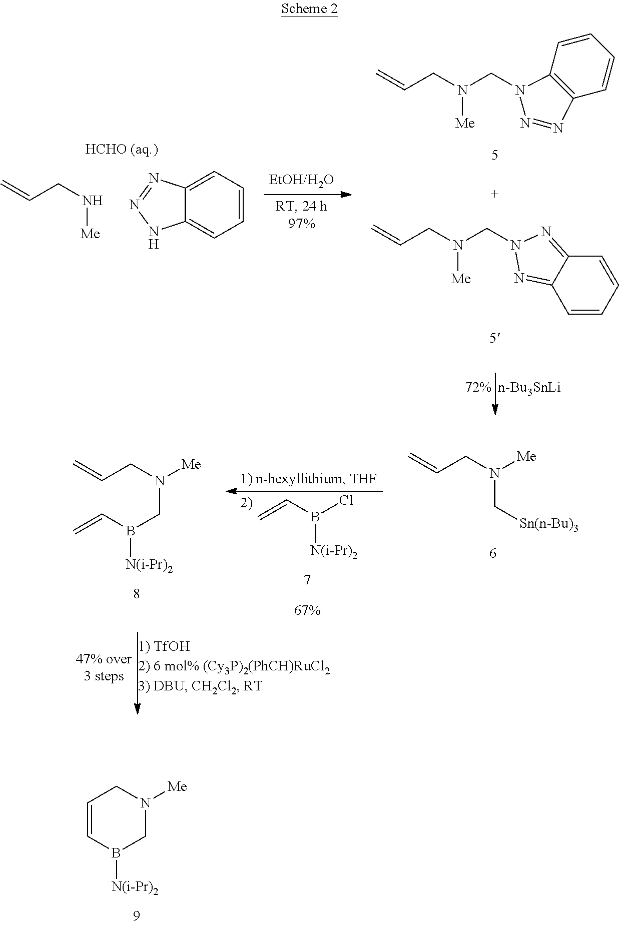

With precursor 9 in hand, we were one dehydrogenation step away from the desired target 1,3-azaborine 4. However, to the best of our knowledge, there are no reported examples of aromatization by eliminating two hydrogen atoms from meta positions in a six-membered ring system. Indeed, our first attempts employing DDQ resulted in intractable mixtures. Further examination using Pd/C-mediated dehydrogenation of heterocycle 9 afforded what appears to be the desired 1,3-azaborine 4 (¹¹B at δ 29.7 ppm) with good conversion (4:9>19:1), albeit along with an appreciable amount of reduced byproduct 10 (¹¹B at δ 43.6 ppm, 4:10=1.1:1) (Table 1, entry 1). Notably, Pd black performed poorly compared to Pd/C under otherwise identical reaction conditions. These results prompted us to screen for better reaction conditions using Pd/C. The 4:10 ratio is strongly dependent on the solvents used. Among the variety of the solvents examined, benzene was the best solvent in providing the highest 4:10 ratio (Table 1, entry 6 vs. entries 2-5). However, the overall yield of 4 and 10 is only moderate (46˜65%) in the presence of 20 mol % of Pd/C regardless which solvent was used (Table entries 1-6). The effect of catalyst loading is significant. The ratio of 4:10 was increased to 11.5:1 when 50 mol % of Pd/C was used (Table 1, entry 7). However, a concomitant reduction in the overall yield (36% for 4+10) was observed. Although only moderate selectivity was achieved in the presence of 5 mol % Pd/C (4:10=1.8:1), the total yield (93% for 4+10) and the absolute yield of 4 (ca. 60%, Table 1, entry 9) are superior to those entries with higher catalyst loadings. With 5 mol % Pd/C, the ratio of 4:10 can be further improved to 2.2:1 with conservation of total yield when the reaction was carried out at 120° C. (Table 1, entry 10). A further increase in temperature did not result in a better 4:10 ratio (Table 1, entry 11). Thus, under our optimized conditions, the desired product 1,3-azaborine 4 was finally isolated in 25% yield by distillation as a pale yellow liquid.

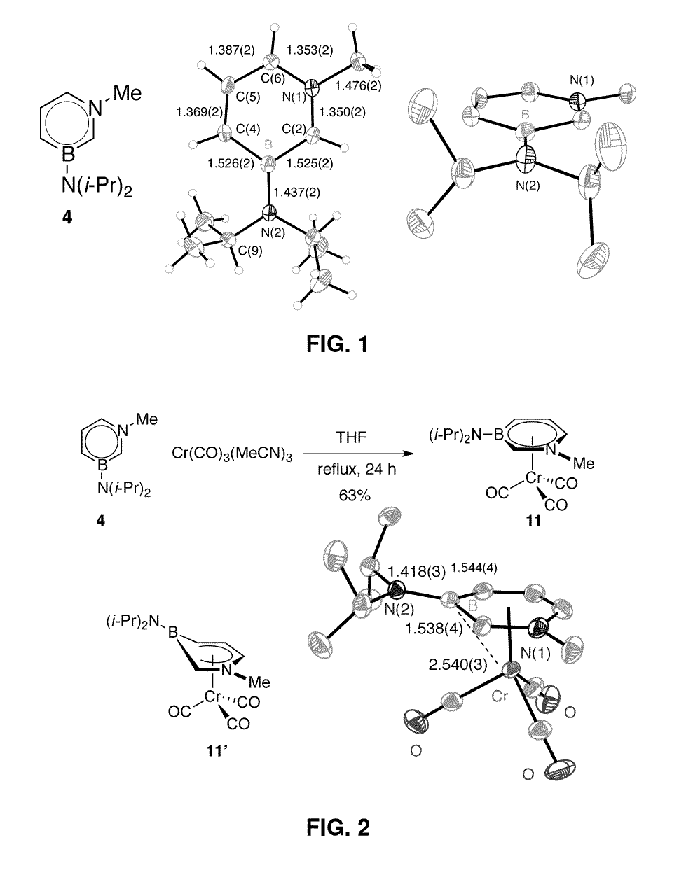

We were able to obtain crystals of 4 suitable for single crystal X-ray diffraction analysis by slow evaporation of a saturated pentane solution of 4 at −30° C. The structure of 4 shown in FIG. 1 unambiguously confirms our structural assignment and provides the first glimpse into the bonding of the 1,3-azaborine motif. The 1,3-azaborine ring is completely planar with 0.01 Å root-mean-square deviation of the ring atoms from the plane. The exocyclic nitrogen atom N(2) in 4 adopts trigonal planar geometry, with sum of the angles around N(2) being 360±0.1°. The C(9)-N(2)-B—C(2) torsion angle of 178.57° and N(2)-B bond distance of 1.437(2) Å suggest significant π-bonding between N(2) and B (sum of sp³ single-bond covalent radii=1.56 Å; the B(sp²)-N(sp²) single bond distance (i.e., perpendicular orientation) is ca. 1.47 Å). Compared to known boron- and/or nitrogen-containing heteroaromatic compounds, all the intra-ring bond distances in 4 are consistent with electron delocalization. For example, the B—C(2) and B—C(4) distances in 4 (1.525(2) and 1.526(2) Å, respectively) are significantly shorter than the sum of B(sp³)-C(sp³) single-bond covalent radii of 1.6 Å, but significantly longer than a B(sp²)=C(sp²) double bond (ca. 1.45 Å). The N(1)-C(2) (1.350(2) Å) and N(1)-C(6) (1.353(2) Å) distances are similar to those in pyridine (1.347 Å). The C(4)-C(5) (1.369(2) Å) and C(5)-C(6) (1.387(2) Å) distances are slightly shorter than those in benzene (1.40 Å) but longer than an average C(sp²)=C(sp²) double bond of ca. 1.34 Å. Notably, there is a smaller difference in the CC bond distances (i.e., difference between the longest and shortest intra-ring C—C bonds) in 1,3-azaborine 4 (0.018 Å) compared to an 1,2-azaborine (ca. 0.056 Å). Overall, the observed bonding in 4 indicates delocalized features and is consistent with computationally predicated values.

TABLE 1

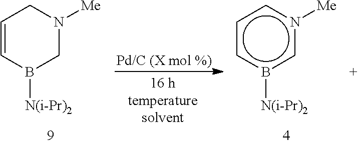

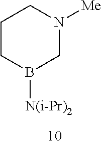

| | catalyst | | | | | yield^{b} (%) of |
|---|---|---|---|---|---|---|
| entry | loading X | solvent | T (° C.) | 4:9^{a} | 4:10^{a} | 4 + 10 |
| 1 | 20 | cyclohexene | 85 | >19:1 | 1.1:1 | 52 |
| 2 | 20 | pentane | 85 | >19:1 | 1.2:1 | 65 |
| 3 | 20 | Et₂O | 85 | >19:1 | 2.9:1 | 46 |
| 4 | 20 | THF | 85 | >19:1 | 3.3:1 | 56 |
| 5 | 20 | toluene | 85 | >19:1 | 2.5:1 | 62 |
| 6 | 20 | benzene | 85 | >19:1 | 3.5:1 | 52 |
| 7 | 50 | benzene | 85 | >19:1 | 11.5:1 | 36 |
| 8 | 10 | benzene | 85 | >19:1 | 2.1:1 | 78 |
| 9 | 5 | benzene | 85 | >19:1 | 1.8:1 | 93 |
| 10 | 5 | benzene | 120 | >19:1 | 2.2:1 | 94 |
| 11 | 5 | benzene | 160 | >19:1 | 1.6:1 | 89 |

^{a}Determined by ¹H NMR analysis.
^{b}Yield of crude material.

We are interested in the reaction chemistry of 1,3-azaborine 4, in particular as it pertains to the aromatic character of this new heterocycle. We determined that 1,3-azaborine 4 reacts with Cr(CO)₃(MeCN)₃ to form the corresponding piano stool complex 11 in 63% yield (Scheme 4). A closer inspection of the structure suggests that compound 11 may be best characterized as an η⁵ π-complex in which the boron atom does not significantly participate in π bonding with the Cr metal (e.g., structure 11′). The six-membered BN heterocycle is not planar in 11; the boron atom is 0.21 Å above the root-mean-square plane containing the other five ring atoms. Compared to the structure of free heterocycle 4 (1.437(2) Å), the B—N(2) distance in 11 (1.418(3) Å) is shortened with significant double-bond character. Furthermore, the B—C distances in 11 (1.538(4) and 1.544(4) Å) are lengthened compared to 4 (1.525(2) and 1.526(2), respectively). Striking is the long Cr—B bond in 11 (2.540(3) Å), which is much longer than that of the parent 1,2-azaborine-Cr(CO)₃ complex (2.301(2) Å). The observed bonding in 11 is similar to other metal complexes of B-amino-substituted boron heterocycles.

In order to explore the substitution chemistry of 1,3-azaborine 4, we treated it with a variety of nucleophiles (e.g., vinylmagnesium bromide, CsF, LiAlH₄, LiOAc, MeOH). Somewhat surprisingly, under those basic and neutral conditions, very little reactivity was observed. The diisopropylamino group might be too strong of a donor to serve as a leaving group. However, we were pleased to see that substitution at boron occurred readily with acetic acid, furnishing a B—OAc substituted 1,3-azaborine 12 in 73% yield (eq 1). We postulate that under acidic conditions, protonation of nitrogen lone pair renders the diisopropylamino substituent a much better leaving group, thus promoting the substitution reaction.

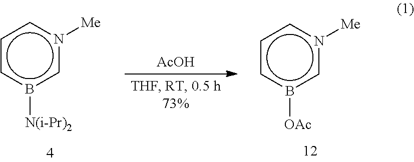

Electrophilic aromatic substitution (EAS) reactions are a hallmark feature for aromatic compounds. 1,3-Azaborine 4 resembles an electron rich aromatic nucleus capable of undergoing EAS reactions. We were happy to determine that treatment of 1,3-azaborine 4 with dimethyl(methylene)ammonium chloride produced the EAS product 13 regioselectively in 75% yield (eq 2).

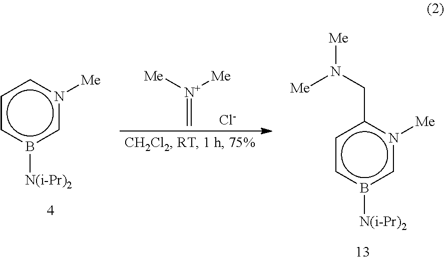

In summary, we synthesized the first example of a 1,3-azaborine. We determined 1,3-azaborines are a thermally stable and isolable family of heterocycles with considerable aromatic character. Single crystal X-ray diffraction analysis is consistent with significant electron delocalization within the six-membered heterocyclic ring. We also demonstrated that 1,3-azaborine 4 undergoes nucleophilic substitutions at boron and electrophilic aromatic substitution reactions.

1,3-azaborine 1 (shown below) is inert towards anionic and neutral nucleophiles. On the other hand, treatment of 1 with acetic acid readily furnished the B-OAc-substituted product 12 shown above. We envisioned that 1,3-azaborine 1 could be converted to B-substituted derivatives under acidic conditions. Scheme 3 illustrates that reaction of precursor 1 with 2 equiv. of HCl produced the B—Cl substituted 1,3-azaborine 2 in 52% yield. Full and clean conversion from 1 to 2 was observed by ¹¹B NMR under the optimized reaction conditions. We believe that the moderate isolated yield is due to loss upon purification via silica gel chromatography. It is worth noting that the relative stability of 1,3-azaborine 2 toward silica gel treatment is in stark contrast to the B—Cl substituted 1,2-azaborine, which undergoes complete degradation upon exposure to silica gel.

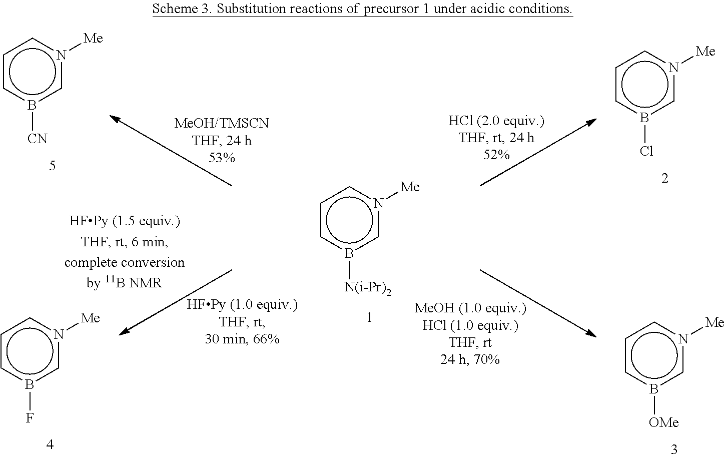

When heterocycle 1 was treated with MeOH, no reaction was observed. However under acidic conditions, i.e., when a 1:1 mixture of MeOH and HCl was reacted with 1, the B-OMe-substituted 1,3-azaborine 3 was generated in 70% isolated yield. Similarly, treatment of 1 with 1.0 equiv. of HF.pyridine gave the fluoride-substituted 1,3-azaborine 4. When 1.5 equiv. of HF.pyridine was used, the substitution reaction was complete within six minutes as determined by ¹¹B NMR. To the best of our knowledge, this is the first isolated example of a B—F substituted azaborine. The facile introduction of the fluorine atom into molecular scaffolds has recently attracted significant interest due to potential applications in PET imaging. The high affinity of boron for fluoride and the relatively facile preparation of 4 may open up opportunities for azaborine structures as arene mimics in this exciting area of research. The B—CN-substituted 1,3-azaborine 5 was synthesized upon exposure of 1 to a 1:1 mixture of MeOH and TMSCN, presumably via the in situ generated HCN. The B—CN connectivity (vs. B—NC) in 5 was confirmed by ¹³C NMR (broad peak at 128.8 ppm (CN)). Despite the successful examples shown in Scheme 3, the acid promoted B-substitution may have limitations. For instance, carbon-based substituents with high pKa C—H bonds (e.g., alkyl, aryl, vinyl, alkynyl) cannot be accessed. A method that would allow nucleophilic substitution at boron under neutral or basic conditions would significantly expand the diversity of 1,3-azaborines. We already determined that heterocycle 1 did not react with a number of anionic nucleophiles due to the weak leaving group ability of the diisopropylamino group. Thus, our strategy was to convert 1 into a 1,3-azaborine intermediate I bearing a good leaving group which in turn can readily undergo nucleophilic substitution (Scheme 4).

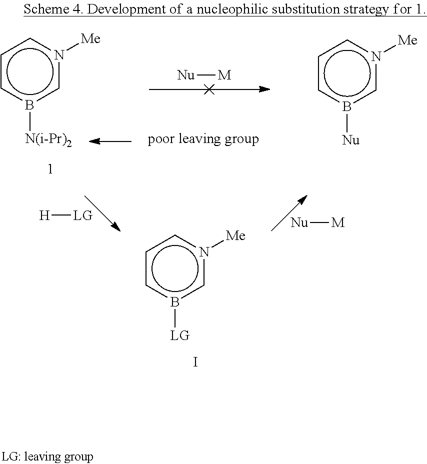

With this strategy in mind, we focused our initial attention on developing B-OAc-substituted 1,3-azaborine 6 as a precursor for nucleophilic substitution reactions based on our prior success in using 6 and LiAlH₄ to produce N-Me-1,3-BN toluene. However, treatment of 6 with the stronger base n-BuLi gave only a trace amount of desired substitution product (Scheme 5, top). For compound 6, we realized that in addition to the desired nucleophilic attack at boron (path a) two possible side reactions may be competitive with a strong nucleophile/base such as n-BuLi: 1) attack at the carbonyl carbon (path b) and 2) deprotonation (path c). Introducing a bulky carboxylate as a leaving group with a quaternary α-carbon could potentially mitigate the problem. Indeed, when 1,3-azaborine 7, which features the bulky pivalate as the leaving group at boron, was reacted with n-BuLi at room temperature, the desired B-n-Bu-substituted compound was formed in 83% yield (Scheme 5, middle). The overall yield over two steps from starting material 1 is 72% due to potential loss of material associated with an additional isolation process. In order to improve the overall efficiency of the substitution protocol starting from 1,3-azaborine 1, we envisioned that the conversion from 1 to 7 and the subsequent nucleophilic substitution reaction could be performed in one single pot with the only operation between the two reactions being the removal of the diisopropylamine byproduct under vacuum. We determined that the two-step one-pot process resulted in 80% overall isolated yield of the B-n-Bu substituted heterocycle, an improvement of 8% over the step-by-step procedure (Scheme 5, bottom).

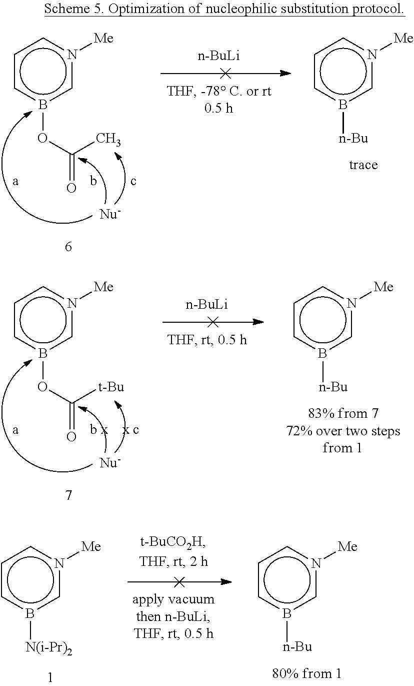

With an optimized general protocol in hand, we then investigated the scope of the substitution reaction. As can be seen from Table 2, the one-pot displacement of the diisopropylamino group in 1 occurs readily in the presence of alkyl-(entry 1), vinyl-(entry 2), aryl-(entry 3), and alkynyl-based (entry 4) nucleophiles. Sterically hindered aryl nucleophiles such as mesityllithium also readily undergo substitution (entry 5). Interestingly, without first converting the diisopropylamino group to B-pivalate-substituted intermediate 7, phenol and t-butyl alcohol failed to react with 1,3-azaborine 1 even in the presence of HCl.

TABLE 2
Synthesis of B-Substituted 1,3-Azaborines
through Nucleophilic Substitution

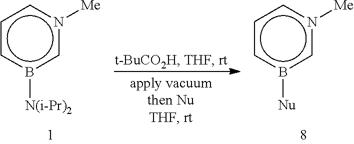

| entry | nucleophile (Nu) | product | yield (%)^{a} |
|---|---|---|---|
| 1 | Li—n-Bu | 8a | 80 |
| 2 | BrMg-vinyl | 8b | 76 |
| 3 | BrMg—Ph | 8c | 94 |
| 4 | BrMg—≡—Ph | 8d | 89 |
| 5 | Li-Mesityl | 8e | 87 |
| 6 | Li—OPh | 8f | 99 |
| 7 | K—Ot-Bu | 8g | 99 |
| 8 | K—N(SiMe₃)₂ | 8h | 69 |
| 9 | Cs—F | 4 | 81 |
| 10 | Et₃N/HOMe^{b} | 3 | 96 |

^{a}Isolated yield.
^{b}Vacuum was not applied after treatment of 1 with pivalic acid.

On the other hand, using the optimized one-pot substitution protocol, heteroatom-based nucleophiles become suitable as reaction partners. Use of phenoxide (entry 6) and t-butoxide (entry 7) resulted in the formation of the corresponding products 8f and 8g in high yields. The diisopropylamino substituent in 1 can be readily converted to another amino functionality such as bis(trimethylsilyl)amino group employing KN(SiMe₃)₂ as the nucleophile, furnishing 8h in 69% yield (entry 8). Notably, in addition to the HF.pyridine reagent, the B—F substituted 1,3-azaborine 4 can also be formed via a nucleophilic protocol using CsF (entry 9). Finally, the one-pot protocol converts 1,3-azaborine 1 to the B-OMe derivative 3 with MeOH/NEt₃ (entry 10).

Among the azaborine series (1,2-, 1,3-, and 1,4-azaborines), the 1,3-isomer is the only family that cannot not be satisfactorily represented by a Lewis structure without invoking formal charges (see below).

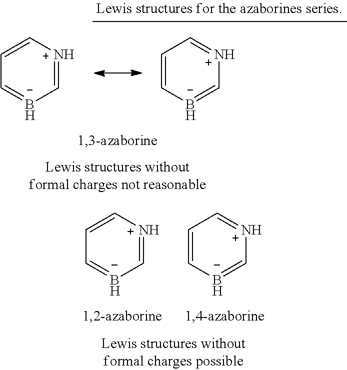

With a library of 1,3-azaborines now readily accessible, we have crystallographically characterized compounds 8c, 8d, and 8f. 1,3-Azaborine 8f is the 1,3-BN isostere of a diphenylether (specifically, 1-methyl-3-phenoxybenzene). The observed bonding between the boron and exocyclic oxygen in 8f is revealing (see below): The exocyclic oxygen atom of 8f is mostly sp²-hybridized, with ∠B—O—C=123.8(2)°. The C—O—B—C(2) torsion angle of 170.4(2)° and the B—O bond distance of 1.422(3) Å suggest some double-bond character between oxygen and boron (sum of single-bond covalent radii=1.48 Å). However, compared to a typical B-alkoxide-substituted 1,2-azaborine (B—O=1.389(2) Å), the observed B—O distance in 8f is by 0.03 Å longer, indicating a significantly weaker B—O p bonding in a 1,3-azaborine vs. a 1,2-azaborine. In a more direct comparison of diphenylether structures, we prepared 1,2-azaborine 9 and determined its corresponding B—O distance, which is 1.392(1)Å (see below). The weaker B—O p bonding in 1,3-azaborines in comparison to 1,2-azaborines is consistent with the electrostatic potential map calculations in which a highly delocalized intra-ring p electron system renders the boron atom relatively less capable of accepting p electrons from exocyclic substituents.

Another striking feature of the solid-state structure of 8f is the short B—C(2) distance of 1.476(5) Å. However, the crystallographically determined short B—C(2) distance is not predicted by gas-phase density functional theory (DFT) calculations at B3LYP/DZVP2¹⁷ level (B—C(2)=[1.516 Å]). The observed B—C(2) distance for the B-diisopropylamino-substituted 1,3-azaborine 1 is 1.525(2) Å and that for 8c and 8d are 1.508(3) Å and 1.498(2)

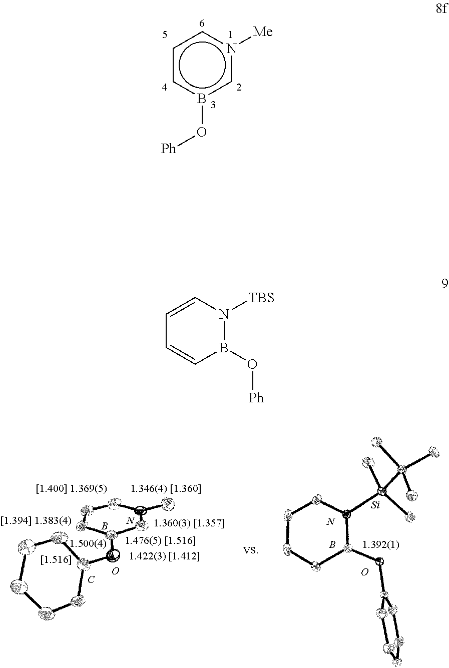

ORTEP illustrations, with thermal ellipsoids drawn at the 35% probability level, of 8f and 9. Numbers in brackets are optimized gas-phase bond distances calculated at the B3LYP/DZVP2 level.
Å, respectively, and the calculated DFT values are consistent with. Thus, the observed B-substituent-dependent intra-ring solid-state B—C(2) bond distances range from 1.476 Å to 1.525 Å (i.e., a difference of ˜0.05 Å), which is relatively large and distinct from 1,2-azaborines and arenes. For instance, the solid-state intra-ring B—C(3) distance for a representative B—OR (OR=methylglycolate) substituted 1,2-azaborine is 1.518(2) Å and that for a B—NPh₂ substituted 1,2-azaborine is also 1.518(2) Å. Similarly, a representative diarylether exhibits a corresponding intra-ring C—C distance of 1.379(4) Å²² vs. a C—C distance of 1.404(2) Å for a representative N,N-diisopropylaniline (difference of 0.025 Å). Overall, the observed intra-ring bond distances in 1,3-azaborines 1, 8c, 8d, and 8f are not consistent with a single Lewis structure description, which corroborates previous theoretical predictions of a significantly electron-delocalized structure.

To more quantitatively evaluate the aromatic character of 1,3-azaborines, we calculated the nucleus-independent chemical shift NICS(0) and NICS(1) values for the BN-heterocyclic portion of compounds 1, 8c, 8d, and 8f (see below). Without exception, the NICS values for the illustrated 1,3-azaborines are more negative than the corresponding B-substituted 1,2-azaborines but less negative than the corresponding carbonaceous arenes. Thus, based on the NICS values, 1,3-azaborine exhibits aromaticity that is intermediate between benzene and 1,2-azaborine.

| | NICS(0)/ NICS(1) | 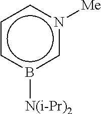 1 | 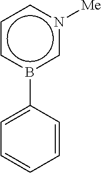 8c | 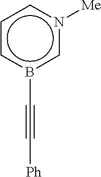 8d | 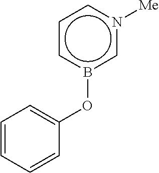 8f |
|---|---|---|---|---|---|
| increasing ↑ | arene | −8.3/−9.0 | −7.8/−9.6 | −8.3/−9.5 | −9.2/−9.5 |
| aromatic | 1,3- | −5.2/−6.6 | −5.9/−7.9 | −6.5/−8.2 | −6.6/−7.6 |
| | azaborine | | | | |
| character | 1,2- | −3.4/−4.5 | −4.4/−6.0 | −5.1/−6.5 | −4.7/−5.4 |
| | azaborine | | | | |

Calculated NICS(0) and NICS(1) values for 1,3-azaborines 1, 8c, 8d, 8f and their corresponding 1,2-azaborine and carbonaceous (arene) counterparts.

Finally, we have predicted the resonance stabilization energy (RSE) of the parent 1,3-azaborine to be approximately 29 kcal/mol. This value was derived computationally (G3MP2) through equations (1) and (2), which reveal that the RSE of the parent 1,3-azaborine is ca. 5 kcal/mol (average of 3.5 and 6.6 kcal/mol) less than that of benzene (RSE=34.1 kcal/mol). Compared to a similar analysis for the parent 1,2-azaborine (RSE=21 kcal/mol), the parent 1,3-azaborine exhibits a RSE that is higher, which is consistent with the structural analysis and NICS calculations.

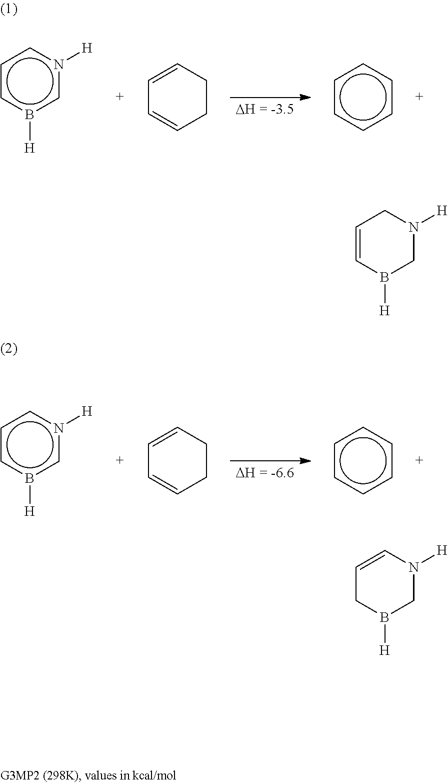

Thus, in terms of structure, magnetism, and resonance energy stabilization presented in this work, we conclude that 1,3-azaborines should be considered more aromatic than 1,2-azaborines. It appears that the crucial factors governing the relative aromaticity between 1,2- and 1,3-azaborines originate in the extent of p electron delocalization as well as the lack of a B—N bond in the 1,3-isomer. The stronger capability for the 1,2-azaborine to localize its p electrons in the BN bond region may disrupt electron delocalization and result in a relatively lower aromatic character.

In summary, we developed the first general synthetic toolbox for the synthesis of B-substituted 1,3-azaborines. As part of the scope of our method, we synthesized and isolated the first example of a B—F substituted azaborine. Structural analysis in the solid state revealed a B-substituent dependent intra-ring bond distance for the B—C(2) bond. The relatively long B—O distance, the calculated NICS values for 1,3-azaborines 1, 8c, 8d, and 8f, and the resonance stabilization energy evaluation suggest that 1,3-azaborines are highly aromatic. In view of the ubiquity and importance of arenes in biomedical research and materials science, the synthetic methods presented in this work represent a significant advance in realizing the potential of BN/CC isosterism, specifically the use of 1,3-azaborines, in these important areas of research.

The compounds disclosed herein may be useful in organic light-emitting diodes, materials for non-linear optics, sensor materials and/or structural diversification of biologically active compounds.

Several illustrative embodiments are described below in the following consecutively numbered paragraphs:

1. A compound having a structure of:

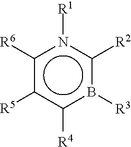

wherein each of R¹-R⁶ is individually H, halogen, hydroxyl, amino, optionally substituted alkoxy, optionally substituted alkyl, optionally substituted alkenyl, optionally substituted alkynyl, optionally substituted aryl, optionally substituted acyl, optionally substituted acyloxy, optionally substituted cycloalkyl, optionally substituted heterocycloalkyl, optionally substituted heteroaryl, optionally substituted aryloxy, optionally substituted heteroaryloxy, optionally substituted heterocycloxy, halogenated alkyl, thioether, optionally substituted thiol, ester, aminocarbonyl, amido, nitro, silyl, sulfonyl, sulfonyl, or phosphino.

2. The compound of paragraph 1, wherein each of R², R⁴, R⁵ and R⁶ is H.

3. The compound of paragraph 1 or 2, wherein R¹ and R³ are not each H.

4. The compound of any one of paragraphs 1 to 3, wherein R¹ is an alkyl.

In view of the many possible embodiments to which the principles of the disclosed invention may be applied, it should be recognized that the illustrated embodiments are only preferred examples of the invention and should not be taken as limiting the scope of the invention.

What is claimed is:

1. A compound having a structure of: 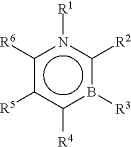
wherein each of R¹-R⁶ is individually H, halogen, hydroxyl, amino, optionally substituted alkoxy, optionally substituted alkyl, optionally substituted alkenyl, optionally substituted alkynyl, optionally substituted aryl, optionally substituted acyl, optionally substituted acyloxy, optionally substituted cycloalkyl, optionally substituted heterocycloalkyl, optionally substituted heteroaryl, optionally substituted aryloxy, optionally substituted heteroaryloxy, optionally substituted heterocycloxy, halogenated alkyl, thioether, optionally substituted thiol, ester, aminocarbonyl, amido, nitro, silyl, sulfonyl, sulfonyl, or phosphino.

2. The compound of claim 1, wherein each of R², R⁴, R⁵ and R⁶ is H.

3. The compound of claim 1, wherein R¹ and R³ are not each H.

4. The compound of claim 1, wherein R¹ is an alkyl.

5. The compound of any one of claim 1, wherein R³ is optionally substituted alkyl, optionally substituted alkenyl, optionally substituted aryl, optionally substituted alkynyl, optionally substituted aryloxy, optionally substituted alkoxy, amino, or halogen.

6. The compound of claim 5, wherein R¹ is an alkyl.

7. The compound of claim 5, wherein R¹ is methyl.

8. The compound of claim 1, wherein R³ is an alkylamino.

9. The compound of claim 1, wherein R¹ is a C₁-C₆ alkyl.

10. The compound of claim 1, wherein R³ is H, halogen, hydroxyl, amino, alkoxy, acyl, acyloxy, heteroaryl, or heterocycloxy.

11. The compound of claim 1, wherein R³ is F.
